(19) United States
(12) Patent Application Publication
(10) Pub. No.: US 2014/0274542 A1
(43) Pub. Date: Sep. 18, 2014

(54) LOCKING COLLAR FOR VEHICULAR DIFFERENTIAL

(71) Applicant: HONDA MOTOR CO., LTD., Tokyo (JP)

(72) Inventors: Dustin Schroeder, Milford Center, OH (US); Bunzo Seki, Dublin, OH (US); Masahiro Yamaguchi, Dublin, OH (US); Shinya Nishiyama, Tokorozawa-shi (JP); Hiroaki Tomita, Shiki-shi (JP)

(73) Assignee: HONDA MOTOR CO., LTD., Tokyo (JP)

(21) Appl. No.: 13/828,502

(22) Filed: Mar. 14, 2013

(51) Int. Cl. F16H 48/24

(52) U.S. Cl. CPC F16H 48/24
USPC 475/231

(57) ABSTRACT

A locking collar for association with a differential and configured to facilitate operation of vehicle in one of a two-wheel drive mode, a four-wheel drive mode, and a four-wheel drive mode with a locked differential is provided. The locking collar includes a first set of internal splines.

### TECHNICAL FIELD

A four-wheel drive (4WD)/differential lock mechanism is provided for use in axle assemblies of motor vehicles.

### BACKGROUND

Various motor vehicle differentials are known in the art. Some conventional vehicles can include a front differential that is arranged to facilitate operation of the vehicle in one of a two-wheel drive (2WD) mode, a 4WD mode, and a 4WD mode with one or more locked differentials (e.g., a 4WD/lock mode).

### SUMMARY

In accordance with one embodiment, a vehicular drive train comprises a first axle, a second axle, and a differential. The differential comprises a stationary case, a rotatable carrier, at least two spider gears, a first side gear, a second side gear, a shaft, an axle tube, and a locking collar. The rotatable carrier is journalled within stationary case. The rotatable carrier has a neck portion that includes a first set of external splines. The at least two spider gears are rotatably coupled to the rotatable carrier. The first side gear is meshed with each of the at least two spider gears. The first axle is coupled with the first side gear and is rotatable together with the first side gear. The second side gear is meshed with each of the at least two spider gears. The second axle is coupled with the axle tube and is rotatable together with the axle tube. The shaft is coupled with the second side gear and is rotatable together with the second side gear. The shaft includes a second set of external splines. The axle tube is associated with the shaft and includes a third set of external splines. The locking collar is co-axially disposed about the second axle and has a first set of internal splines and a second set of internal splines. The locking collar is longitudinally movable relative to the second axle between a first position, a second position, and a third position. The locking collar is rotatable with the second axle. The locking collar has a first internal diameter corresponding with the first set of internal splines. The locking collar has a second internal diameter corresponding with the second set of internal splines. The second internal diameter is greater than the first internal diameter. When the locking collar is in the first position, the first set of internal splines is meshed with the third set of external splines to facilitate operation of a vehicle in a two-wheel drive mode. When the locking collar is in the second position, the first set of internal splines is meshed with the second and third sets of external splines such that the shaft and the second axle are coupled together to facilitate operation of a vehicle in a four-wheel drive mode. When the locking collar is in the third position, the first set of internal splines is meshed with the second and third sets of external splines and the second set of internal splines is meshed with the first set of external splines, such that the rotatable carrier, the shaft, and the second axle are coupled together to facilitate locking of the differential and operation of a vehicle in a locked four-wheel drive mode.

In accordance with another embodiment, a locking collar is provided for association with a differential and configured to facilitate operation of vehicle in one of a two-wheel drive mode, a four-wheel drive mode, and a four-wheel drive mode with a locked differential. The locking collar comprises a first set of internal splines and a second set of internal splines. The locking collar has a first internal diameter at the first set of internal splines, the locking collar has a second internal diameter at the second set of splines, and the second internal diameter is greater than the first internal diameter.

In accordance with yet another embodiment, a vehicle comprises a pair of wheels and a drive train. The drive train comprises a first axle, a second axle, and a differential. Each of the wheels is rotatably supported by one of the first axle and the second axle. The differential comprises a stationary case, a rotatable carrier, at least two spider gears, a first side gear, a second side gear, a shaft, an axle tube, and a locking collar. The rotatable carrier is journalled within stationary case. The rotatable carrier has a neck portion that includes a first set of external splines. The at least two spider gears is rotatably coupled to the rotatable carrier. The first side gear is meshed with each of the at least two spider gears. The first axle is coupled with the first side gear and is rotatable together with the first side gear. The second side gear is meshed with each of the at least two spider gears. The second axle is coupled with the axle tube and is rotatable together with the axle tube. The shaft is coupled with the second side gear and is rotatable together with the second side gear. The shaft has a distal end that includes a second set of external splines. The axle tube is disposed at the distal end of the shaft and includes a third set of external splines. The locking collar is co-axially disposed about the second axle and has a first set of internal splines and a second set of internal splines. The locking collar is longitudinally movable relative to the second axle between a first position, a second position, and a third position. The locking collar is rotatable with the second axle. The locking collar has a first internal diameter corresponding with the first set of internal splines. The locking collar has a second internal diameter corresponding with the second set of internal splines. The second internal diameter is greater than the first internal diameter. When the locking collar is in the first position, the first set of internal splines is meshed with the third set of external splines to facilitate operation of a vehicle in a two-wheel drive mode. When the locking collar is in the second position, the first set of internal splines is meshed with the second and third sets of external splines such that the shaft and the second axle are coupled together to facilitate operation of a vehicle in a four-wheel drive mode. When the locking collar is in the third position, the first set of internal splines is meshed with the second and third sets of external splines and the second set of internal splines is meshed with the first set of external splines, such that the rotatable carrier, the shaft, and the second axle are coupled together to facilitate locking of the differential and operation of a vehicle in a locked four-wheel drive mode.

In accordance with still another embodiment, a locking collar is associated with a differential and configured to facilitate operation of vehicle in one of a two-wheel drive mode, a four-wheel drive mode, and a four-wheel drive mode with a locked differential. The locking collar comprises a first set of internal splines, a shoulder surface, and at least one protrusion. The first set of splines terminate adjacent to the shoulder surface. Said at least one protrusion extends from the shoulder surface. Said at least one protrusion is configured to extend into at least one respective recess defined by a rotatable carrier to facilitate locking of the rotatable carrier and the locking collar together.

### BRIEF DESCRIPTION OF THE DRAWINGS

Various embodiments will become better understood with regard to the following description, appended claims and accompanying drawings wherein:

FIG. 1 is a left rear perspective view depicting a vehicle;

FIG. 2 is a top cross-sectional view depicting a front differential of the vehicle of FIG. 1 and shown schematically, according to one embodiment, with a locking collar shown in a first position such that the vehicle is in a 2WD mode;

FIG. 3 is a top cross-sectional view similar to FIG. 2, but with the locking collar in a second position such that the vehicle is in a 4WD mode;

FIG. 4 is a top cross-sectional view similar to FIG. 2, but with the locking collar in a third position such that the vehicle is in a 4WD/Lock mode;

FIG. 5 is a left cross-sectional view depicting a shift assembly associated with the locking collar of FIGS. 2-4 with certain components removed for clarity of illustration, wherein a pin of the shift assembly extends through a cover member;

FIG. 6 is a front view depicting the shift assembly of FIG. 5 but with the cover member removed for clarity of illustration; and

FIG. 7 is a perspective cross-sectional view of a locking collar, according to another embodiment.

### DETAILED DESCRIPTION

Referring to the drawings, wherein like reference numbers indicate the same or corresponding elements throughout the views, FIG. 1 illustrates a vehicle 10 that can incorporate a drive train 12 associated with front wheels (e.g., 14) and rear wheels 16. The drive train 12 can be used on a small utility vehicle, such as vehicle 10 shown in FIG. 1 and can also be used on a variety of other vehicles including all terrain vehicles, golf carts, “dune buggies”, automobiles and trucks.

The vehicle 10 includes an engine (not shown) associated with the drive train 12 for transferring torque to the front wheels (e.g., 14) and/or rear wheels 16. The engine can be an internal combustion engine, which can use one or more of a variety of fuels, or any other suitable source of motive power such as an electric motor. Referring to FIG. 2, the drive train 12 can include a front differential 20, an input member 22 that can be coupled to the engine (e.g., with a prop shaft 54 shown in FIGS. 2-4), a left front axle 24, and a right front axle 26. The left and right front axles 24, 26 can be rotatably coupled with respective ones of the front wheels (e.g., 14) in a manner known in the art. During operation of vehicle 10, the front differential 20 can transfer torque from the engine via the input member 22 to the left and right front axles 24, 26.

The front differential 20 can include a stationary case 36 and a rotatable carrier 38 that can be journalled within the stationary case 36 by left and right bearings 40, 41. The rotatable carrier 38 can include a neck portion 39 that extends beyond the right bearing 41. The input member 22 is shown to be journalled within the stationary case 36 by a bearing 42. The stationary case 36 can define an opening 44 suitable to permit the input member 22 to extend through the stationary case 36. The bearing 42 can be disposed within the opening 44 and positioned between the input member 22 and portions of the stationary case 36 adjacent to the opening 44. An oil seal 45 can be provided to facilitate fluid sealing of the opening 44. The stationary case 36 can also define left and right openings 46, 48 through which the left and right front axles 24, 26 can extend. Respective oil seals 50, 52 can be provided to facilitate fluid sealing of the left and right openings 46, 48.

The input member 22 can be coupled to a prop shaft 54 and can include a pinion gear 56 that meshes with a ring gear 58 that can be secured to the rotatable carrier 38 by conventional fasteners such as a plurality of bolts (e.g., 59). Accordingly, during operation of vehicle 10, the engine can rotate the prop shaft 54 which can cause the rotatable carrier 38 to rotate. The front differential 20 is further shown to include a pair of spider gears 60, a left side gear 61, and a right side gear 62. The spider gears 60 can be rotatably coupled to the rotatable carrier 38 by a shaft 63. Accordingly, the spider gears 60 can be rotatable with respect to the rotatable carrier 38 and rotatable together with the rotatable carrier 38. Each spider gear 60 can mesh with each of the left and right side gears 61, 62. It will be appreciated that in other embodiments a front differential can include more than two spider gears.

As shown in FIG. 2, the left side gear 61 can be coupled to an inboard end of the left front axle 24. In one embodiment, the left front axle 24 can be splined to the left side gear 61 but in other embodiments can be coupled with the left side gear 61 in any of a variety of suitable alternative arrangements, such as, for example, the left front axle 24 and the left side gear 61 being formed together in a one-piece construction. A pinion shaft 64 can extend from the right side gear 62 towards the right front axle 26 and can be rotatable together with the right side gear 62. In one embodiment, the pinion shaft 64 is shown to be coupled with the right side gear 62 in a one-piece construction, as generally shown in FIG. 2. In other embodiments, a pinion shaft can be coupled with a right side gear in any of a variety of suitable alternative arrangements. For example, a pinion shaft and a right side gear can be provided in a two-piece construction with the pinion shaft splined to an interior of the right side gear.

An axle tube 66 can be disposed at a distal end 65 of the pinion shaft 64 and can be configured to rotate with respect to the pinion shaft 64. The axle tube 66 can be rotatably supported by a bearing 68 that is interposed between the distal end 65 and the axle tube 66. It will be appreciated that an axle tube can be associated with a pinion shaft in any of a variety of suitable alternative arrangements. For example, an axle tube can include a nipple that extends into the pinion shaft and is supported by an internal bearing. In such an example, the internal bearing can be located about midway between opposite ends of the pinion shaft. In one embodiment, an inboard end of the right front axle 26 can be splined to the axle tube 66, as generally shown in FIG. 2. But in other embodiments, the right front axle 26 can be coupled with the axle tube 66 in any of a variety of suitable alternative arrangements. For example, a right and rear front axle can be formed together in a one-piece construction.

The front differential 20 can further include a 4WD/differential lock mechanism that includes a locking collar 72. As illustrated in FIGS. 2-4, the locking collar 72 can be coaxially disposed about the axle tube 66 and can be longitudinally slidable with respect to the right front axle 26 between a first position (FIG. 2), a second position (FIG. 3), and a third position (FIG. 4). When the locking collar 72 is in the first position, as illustrated in FIG. 2, the vehicle 10 can operate in a 2WD mode. When the locking collar 72 is in the second position, as illustrated in FIG. 3, the vehicle 10 can operate in a 4WD mode. When the locking collar 72 is in the third position, as illustrated in FIG. 4, the vehicle 10 can operate in a 4WD mode with the rotatable carrier 38 and the right side gear 62 locked (e.g., a 4WD/lock mode with the front differential 20 locked). Shifting between any of these modes can be desirable in certain instances, for example when one of the front wheels (e.g., 14) is spinning due to engagement with a slippery surface such as ice, snow, sand, mud etc.

The locking collar 72 can have a first set of internal splines 74 longitudinally spaced from a second set of internal splines 76. Each of the axle tube 66, the pinion shaft 64, and the neck portion 39 can have first, second, and third sets of external splines 78, 80, 82, respectively. It is to be appreciated that splines described herein as being internal splines, such as the first and second sets of internal splines 74, 76, should be understood to mean that the splines of each respective set of splines are spaced from each other and extend radially inwardly. Additionally, it is to be appreciated that splines which are described herein as being external splines, such as the first, second, and third sets of external splines 78, 80, 82, should be understood to mean that the splines of each respective set of splines are spaced from each other and extend radially outwardly from a generally cylindrical surface.

When the locking collar 72 is in the first position, as illustrated in FIG. 2, the locking collar 72 can be splined to the axle tube 66 with the first set of internal splines 74 meshed with the first set of external splines 78, but spaced longitudinally from the second set of external splines 80. The second set of internal splines 76 is spaced from the third set of external splines 82. In this position, the axle tube 66 is not coupled with the pinion shaft 64, and the left and right front axles 24, 26 are free to rotate with respect to one another such that the vehicle 10 is in a 2WD mode. In this configuration, it will be appreciated that any rotation of the left front axle 24 and/or any torque provided to the input member 22 while the locking collar 72 is in the first position can cause the pinion shaft 64 to rotate with respect to the right front axle 26.

When the locking collar 72 is moved to the second position, as illustrated in FIG. 3, the locking collar 72 can be splined to each of the axle tube 66 and the pinion shaft 64 with the first set of internal splines 74 being meshed with each of the first and second sets of external splines 78, 80. The second set of internal splines 76 is spaced from the third set of external splines 82. The axle tube 66 and the pinion shaft 64 can accordingly be coupled together with each of the left and right front axles 24, 26 powered by the engine via the input member 22 such that the vehicle 10 is in a 4WD mode. The front differential 20 can operate as an open or limited slip differential such that slowing the rotation of one of the front wheels (e.g., 14) can increase the rotation of the other front wheel.

When the locking collar 72 is moved to the third position, as illustrated in FIG. 4, the locking collar 72 can remain splined to the axle tube 66 and the pinion shaft 64 (e.g., with the first set of internal splines 74) and can also be splined to the neck portion 39 of the rotatable carrier 38 with the second set of internal splines 76 being meshed with the third set of external splines 82. The axle tube 66, the pinion shaft 64, and the rotatable carrier 38 can accordingly be coupled together such that each of the left and right front axles 24, 26 can be powered by the engine via the input member 22 and can be locked together (e.g., in a differential lock mode) such that the vehicle 10 is in a 4WD/lock mode.

As illustrated in FIG. 2, the locking collar 72 can have a first internal diameter d1 at the first set of internal splines 74 and can have a second internal diameter d2 at the second set of internal splines 76. The first internal diameter d1 can correspond to respective outer diameters d11, d111 (FIG. 3) of the pinion shaft 64 and the axle tube 66 such that the first set of internal splines 74 can mesh with, and are able to slide with respect to, the first and second sets of external splines 78, 80. The neck portion 39 of the rotatable carrier 38 is shown in FIG. 3 to have an outer diameter d22 that is greater than the outer diameters d11, d111 of the pinion shaft 64 and the axle tube 66. The second internal diameter d2 of the locking collar 72 is accordingly greater than the first internal diameter d1 and can correspond with the outer diameter d22 of the neck portion 39 such that the second set of internal splines 76 mesh with, and are able to slide with respect to, the third set of external splines 82.

As illustrated in FIGS. 2-4, the locking collar 72 can include a shoulder surface 84 that extends between the first and second set of internal splines 74, 76. The width of the shoulder surface 84 can be the difference between the first diameter d1 and the second diameter d2. The neck portion 39 of the rotatable carrier 38 can include a neck surface 86 that faces the shoulder surface 84. When the locking collar 72 is in the third position, the shoulder surface 84 and the neck surface 86 can remain spaced from each other to provide clearance for the neck portion 39 of the rotatable carrier 38, as shown in FIG. 4. In one embodiment, the space between the shoulder surface 84 and the neck surface 86 can define a reservoir. In such an embodiment, when the locking collar 72 initially engages the neck portion 39 (e.g., the second set of internal splines 76 begin to mesh with the third set of external splines 82), differential fluid might be captured between the neck portion 39 and the locking collar 72. As the locking collar 72 continues to move into the third position, any differential fluid between the neck portion 39 and the locking collar 72 can escape into the reservoir defined between the shoulder surface 84 and the neck surface 86. The differential fluid can therefore flow freely into the reservoir, thereby reducing the likelihood that the differential fluid becomes compressed between the neck portion 39 and the locking collar 72 and inhibits movement of the locking collar 72 into the third position. In another embodiment, the space between the shoulder surface 84 and the neck surface 86 might not define a reservoir for differential fluid but instead might simply provide enough clearance to prevent the neck surface 86 and the shoulder surface 84 from contacting each other causing an incomplete shift. In another embodiment, the second set of splines 76 can extend to the shoulder surface 84.

The 4WD/diff lock mechanism 70 can include a shift assembly 88, as illustrated in FIG. 5, that facilitates shifting of the locking collar 72 among the first, second, and third positions. The shift assembly 88 can include a shift arm 92 that is pivotally coupled to the stationary case 36 by a pin 90. The shift arm 92 can be releasably secured to the pin 90 with a bolt 96. A resilient member 94 can be supported by the pin 90 at one end. As illustrated in FIGS. 5 and 6, the other end of the pin 90 can extend through a cover member 97 and can be coupled with a selector arm 98. The cover member 97 can be releasably attached to an external wall 99 of the stationary case 36 through welding, bolts, or any of a variety of suitable alternatively fastening arrangements. The selector arm 98 can be associated with a selector (not shown) that facilitates manual or automatic control of the shift assembly 88. In one embodiment, the selector can comprise a manual shift selector (not shown) that is coupled to the selector arm 98 with a Bowden-type cable. In such an embodiment, the manual shift selector can extend into a passenger compartment of the vehicle 10 such that it be actuated by an operator of the vehicle 10 to select the operation of the vehicle 10 between one of the 2WD mode, the 4WD mode, and the 4WD/lock mode.

As illustrated in FIG. 5, the shift assembly 88 can include a fork 89 that is engaged with the locking collar 72. The fork 89 can include a protrusion 100 and the shift arm 92 can include a protrusion 102. The resilient member 94 can include a pair of arms 104, 106 that extend along the protrusions 100, 102 such that each of the protrusions 100, 102 is sandwiched between the arms 104, 106. The fork 89 and the protrusion 100 are shown apart from the rest of the shifting assembly 88 for clarity of illustration. It will be appreciated that the location of the shifting assembly 88 in FIGS. 2-4 can be understood from the depiction of the shifting assembly 88 and the external wall in FIGS. 5 and 6.

When the selector arm 98 is moved, the pin 90 can pivot the shift arm 92. The arms 104, 106 of the resilient member 94 can cooperate with the protrusions 100, 102 to move the locking collar 72 in response to the pivoting of the shift arm 92. If movement of the locking collar 72 is obstructed when the shift arm 92 is pivoted (such as when any of the neck portion 39, pinion shaft 64, and/or axle tube 66 are rotating in opposite directions or at significantly different speeds), the resilient member 94 can cooperate with the protrusions 100, 102 to permit relative movement between the locking collar 72 and the shift arm 92. When the locking collar 72 moves relative to the shift arm 92, the arms 104, 106 can be spread apart from each other and can bias the locking collar 72 towards the shift arm 92. For example, if the selector arm 98 is actuated to move the locking collar 72 from the first position to the second position, and the relative rotation between the pinion shaft 64 and the axle tube 66 prevents the locking collar 72 from moving to the second position, the shift arm 92 can rotate relative to the locking collar 72. Since the locking collar 72 is held in the first position by the relative rotation between the pinion shaft 64 and the axle tube 66, the protrusions 100, 102 can become spread apart, thereby spreading the arms 104, 106 of the resilient member 94 apart and placing them under tension. Once the relative rotation between the pinion shaft 64 and the axle tube 66 is more appropriate to permit movement of the locking collar 72 into the second position, the locking collar 72 can be urged into the second position by the arms 104, 106. It will be appreciated that although the shift assembly 88 is shown to be a fork-type assembly, any of a variety of suitable alternative arrangements can be provided, such as an arrangement having a ball-screw being disposed in a shift fork.

As illustrated in FIG. 5, a stopper 108 can be mounted adjacent to the shift arm 92 and can be biased (e.g., with a spring) into contact with a distal end 110 of the shift arm 92. As illustrated in FIG. 6, the distal end 110 of the shift arm 92 can define three recesses 112. When the shift arm 92 is pivoted to move the locking collar 72, the distal end 110 can slide along the stopper 108 and, once it becomes aligned with one of the recesses 112, the stopper 108 can project into the recess 112 to hold the shift arm 92 in place. The location of each of the recesses 112 can correspond with operation of the vehicle 10 in one of the 2WD mode, the 4WD mode, and the 4WD/lock mode.

It will be appreciated that the locking collar 72 can remain splined to the axle tube 66 in any of the first, second, and third positions such that it remains rotatable together with the right front axle 26 during operation of the vehicle 10 in any of the 2WD mode, the 4WD mode, and the 4WD/lock mode. In addition, the locking collar 72 can also be rotatable together with the pinion shaft 64 and/or the neck portion 39 depending upon whether the locking collar 72 is in the second or third position. The locking collar 72 can therefore be configured to rotate with respect to the fork 89. As illustrated in FIG. 6, the fork 89 can include arms (e.g., 114) that are configured to interact with the circumferentially extending groove 116 (FIGS. 2-4) defined by the locking collar 72. In one embodiment, the arms 114 include a pair of radially inwardly extending protrusions (not shown) that can ride along the groove 116 to permit rotation of the locking collar 72 together with the rotatable carrier 38, the pinion shaft 64, and/or the axle tube 66. In one embodiment, the radially inwardly extending protrusions can be journalled with respect to the circumferentially extending groove 116 (FIGS. 2-4) but in other embodiments, can be provided with any of a variety of suitable alternative reduced friction-type interfaces.

Referring now to FIG. 7, a locking collar 172 is illustrated according to another embodiment. The locking collar 172 can be similar to, or the same in many respects to the locking collar 72, shown in FIGS. 2-5. For example, the locking collar 172 can include a set of internal splines 174 that terminate adjacent a shoulder surface 184. The locking collar 172 however, might not include a second set of splines (e.g., 76) spaced from the internal splines 174. Instead, the locking collar 172 can include multiple protrusions 177 (e.g., two shown) that extend from the shoulder surface 184. When the locking collar 172 is in the third position, each of the protrusions 177 can extend into respective recesses (not shown) defined by a rotatable carrier (e.g., a neck portion) to facilitate locking of the rotatable carrier and the locking collar 172 together.

It will be appreciated that although a front differential is described above, a 4WD/diff lock mechanism and/or shift assembly can be provided on any of a variety of suitable alternative differential arrangements (e.g., a rear differential).

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto.

1. A vehicular drive train comprising:
a first axle;
a second axle; and
a differential, the differential comprising:
a stationary case;
a rotatable carrier journalled within stationary case, the rotatable carrier having a neck portion, the neck portion including a first set of external splines;
at least two spider gears rotatably coupled to the rotatable carrier;
a first side gear meshed with each of the at least two spider gears, the first axle being coupled with the first side gear and rotatable together with the first side gear;
a second side gear meshed with each of the at least two spider gears, the second axle being coupled with the axle tube and rotatable together with the axle tube;
a shaft coupled with the second side gear and rotatable together with the second side gear, the shaft including a second set of external splines;
an axle tube associated with the shaft and including a third set of external splines; and
a locking collar co-axially disposed about the second axle and having a first set of internal splines and a second set of internal splines, the locking collar being longitudinally movable relative to the second axle between a first position, a second position, and a third position and the locking collar being rotatable with the second axle;
wherein:
the locking collar has a first internal diameter corresponding with the first set of internal splines;
the locking collar has a second internal diameter corresponding with the second set of internal splines;
the second internal diameter is greater than the first internal diameter;
when the locking collar is in the first position, the first set of internal splines is meshed with the third set of external splines to facilitate operation of a vehicle in a two-wheel drive mode;
when the locking collar is in the second position, the first set of internal splines is meshed with the second and third sets of external splines such that the shaft and the second axle are coupled together to facilitate operation of a vehicle in a four-wheel drive mode; and
when the locking collar is in the third position, the first set of internal splines is meshed with the second and third sets of external splines and the second set of internal splines is meshed with the first set of external splines, such that the rotatable carrier, the shaft, and the second axle are coupled together to facilitate locking of the differential and operation of a vehicle in a locked four-wheel drive mode.

2. The vehicular drive train of claim 1 wherein the first axle is splined to the first side gear and the second axle is splined to the axle tube.

3. The vehicular drive train of claim 1 wherein the axle tube is rotatably supported by the distal end of the shaft.

4. The vehicular drive train of claim 3 wherein the differential further comprises a bearing interposed between the axle tube and the distal end of the shaft.

5. The vehicular drive train of claim 1 wherein the differential further comprises a ring gear coupled with the rotatable carrier.

6. The vehicular drive train of claim 5 further comprising an input member configured for powering by a motive source, the input member having a pinion gear meshed with the ring gear.

7. The vehicular drive train of claim 1 wherein the differential further comprises a shift assembly comprising a fork and shift arm, the fork having a plurality of arms that interact with a circumferentially extending groove defined by the locking collar.

8. The vehicular drive train of claim 7 wherein the differential further comprises a pin and a resilient member, the shift arm being coupled with the pin, and the resilient member being supported on the pin and engaged with the fork.

9. The vehicular drive train of claim 8 wherein the fork comprises a first protrusion, the shift arm comprises a second protrusion, and the resilient member comprises a pair of arms, and wherein each of the protrusions is sandwiched between the pair of arms.

10. The vehicular drive train of claim 9 wherein the resilient member cooperates with the protrusions to permit relative movement between the locking collar and the shift arm and to bias the locking collar towards the shift arm during relative movement between the locking collar and the shift arm.

11. The vehicular drive train of claim 1 wherein the locking collar further comprises a shoulder surface that extends between the first and second sets of internal splines, the neck portion of the rotatable carrier comprises a neck surface that faces the shoulder surface, and when the locking collar is in the third position, the shoulder surface and the neck surface remain spaced from each other.

12. A locking collar for association with a differential and configured to facilitate operation of vehicle in one of a two-wheel drive mode, a four-wheel drive mode, and a four-wheel drive mode with a locked differential, the locking collar comprising:
a first set of internal splines;
a second set of internal splines;
wherein the locking collar has a first internal diameter at the first set of internal splines, the locking collar has a second internal diameter at the second set of splines, and the second internal diameter is greater than the first internal diameter.

13. The locking collar of claim 12 further comprising a shoulder surface that extends between the first and second set of internal splines.

14. A vehicle comprising:
a pair of wheels; and
a drivetrain that comprises:
a first axle; and
a second axle, each of the wheels being rotatably supported by one of the first axle and the second axle; and
a differential comprising:
a stationary case;
a rotatable carrier journalled within stationary case, the rotatable carrier having a neck portion, the neck portion including a first set of external splines;
at least two spider gears rotatably coupled to the rotatable carrier;
a first side gear meshed with each of the at least two spider gears, the first axle being coupled with the first side gear and rotatable together with the first side gear;
a second side gear meshed with each of the at least two spider gears, the second axle being coupled with the axle tube and rotatable together with the axle tube;
a shaft coupled with the second side gear and rotatable together with the second side gear, the shaft having a distal end that includes a second set of external splines;
an axle tube disposed at the distal end of the shaft and including a third set of external splines; and
a locking collar co-axially disposed about the second axle and having a first set of internal splines and a second set of internal splines, the locking collar being longitudinally movable relative to the second axle between a first position, a second position, and a third position and the locking collar being rotatable with the second axle; wherein:
the locking collar has a first internal diameter corresponding with the first set of internal splines;
the locking collar has a second internal diameter corresponding with the second set of internal splines;
the second internal diameter is greater than the first internal diameter;
when the locking collar is in the first position, the first set of internal splines is meshed with the third set of external splines to facilitate operation of a vehicle in a two-wheel drive mode;
when the locking collar is in the second position, the first set of internal splines is meshed with the second and third sets of external splines such that the shaft and the second axle are coupled together to facilitate operation of a vehicle in a four-wheel drive mode; and
when the locking collar is in the third position, the first set of internal splines is meshed with the second and third sets of external splines and the second set of internal splines is meshed with the first set of external splines, such that the rotatable carrier, the shaft, and the second axle are coupled together to facilitate locking of the differential and operation of a vehicle in a locked four-wheel drive mode.

15. The vehicle of claim 14 wherein the shaft is coupled with the second side gear in a one-piece construction.

16. The vehicle of claim 14 wherein the differential further comprises a shift assembly comprising a fork and shift arm, the fork having a plurality of arms that interact with a circumferentially extending groove defined by the locking collar.

17. The vehicle differential of claim 16 wherein the differential further comprises a pin and a resilient member, the shift arm being coupled with the pin, and the resilient member being supported on the pin and engaged with the fork.

18. The vehicle of claim 17 wherein the fork comprises a first protrusion, the shift arm comprises a second protrusion, and the resilient member comprises a pair of arms, and wherein each of the protrusions is sandwiched between the pair of arms and the resilient member cooperates with the protrusions to permit relative movement between the locking collar and the shift arm and to bias the locking collar towards the shift arm during relative movement between the locking collar and the shift arm.

19. The vehicle of claim 14 wherein the locking collar further comprises a shoulder surface that extends between the first and second sets of internal splines, the neck portion of the rotatable carrier comprises a neck surface that faces the shoulder surface, and when the locking collar is in the third position, the shoulder surface and the neck surface remain spaced from each other.

20. A locking collar for association with a differential and configured to facilitate operation of vehicle in one of a two-wheel drive mode, a four-wheel drive mode, and a four-wheel drive mode with a locked differential, the locking collar comprising:
a first set of internal splines;
a shoulder surface, wherein the first set of splines terminate adjacent to the shoulder surface;
at least one protrusion that extends from the shoulder surface,
wherein said at least one protrusion is configured to extend into at least one respective recess defined by a rotatable carrier to facilitate locking of the rotatable carrier and the locking collar together.
